(19) United States
(12) Patent Application Publication
(10) Pub. No.: US 2018/0009651 A1
(43) Pub. Date: Jan. 11, 2018

(54) Fuel Dispenser Utilizing Wi-Fi Direct User Interface

(71) Applicant: Gilbarco Inc., Greensboro, NC (US)

(72) Inventors: Edward Asbell Payne, Kernersville, NC (US); Rodger K. Williams, Siler City, NC (US); Christopher J. Whitley, Greensboro, NC (US)

(21) Appl. No.: 15/642,537

(22) Filed: Jul. 6, 2017

Related U.S. Application Data
(60) Provisional application No. 62/359,012, filed on Jul. 6, 2016.
(60) Provisional application No. 62/403,737, filed on Oct. 4, 2016.
(60) Provisional application No. 62/461,727, filed on Feb. 21, 2017.

(51) Int. Cl. B67D 7/14; H04W 4/02; G06Q 20/22; H04W 4/04; B67D 7/04; G06Q 20/32; B67D 7/06

(52) U.S. Cl. CPC B67D 7/145; H04W 4/046; H04W 4/023; B67D 7/04; G06Q 20/223; B67D 7/068; G06Q 20/327

(57) ABSTRACT

A fuel dispenser comprises fuel flow piping defining a flow path from a source of fuel toward a fueling nozzle. A plurality of fuel handling components are disposed along the fuel flow piping. Control electronics are in operative communication with the fluid handling components. The fuel dispenser includes network circuitry operative to create a wireless peer to peer network with an adjacent vehicle. After creation of such network, the control electronics receive transaction information from the vehicle in electronic form via the network circuitry, and cause at least one function of the fuel dispenser to be controlled for a transaction based on the transaction information.

### PRIORITY CLAIM

This application is based upon and claims priority to U.S. provisional application Ser. No. 62/359,012, filed Jul. 6, 2017, U.S. provisional application Ser. No. 62/403,737, filed Oct. 4, 2016, and U.S. provisional application Ser. No. 62/461,727, filed Feb. 21, 2017. Each of the foregoing applications is incorporated herein by reference in its entirety for all purposes.

### FIELD OF THE INVENTION

The present invention relates generally to service stations at which fuel is dispensed. More particularly, the present invention relates to a fuel dispenser which permits user interaction via ad hoc peer to peer networking.

### BACKGROUND

Retail fueling environments usually include a plurality of fuel dispensers located in a forecourt area outside of a convenience store building. Typically, the fuel dispensers will each be equipped with pay-at-the-pump capability by which the customer can perform the fueling transaction using a user interface on the respective fuel dispenser. For example, the customer can present a credit or debit card using a card reader installed on the fuel dispenser's user interface to pay for the fuel without entering the store. Internally, the dispensers typically contain flow meters, pulsers, control electronics, valves, manifolds, and internal piping. Many of these components are subject to regulatory requirements to maintain a high degree of accuracy.

Accepting payment cards as a method of payment subjects various fuel dispenser components to security standards and regulations promulgated by the Payment Card Industry (“PCI”) and/or EMV (Europay, MasterCard and Visa). These standards were created in an attempt to prevent fraud and other security issues that arise due to the acceptance of payment cards and the transmission of sensitive information associated with the payment cards, such as account number, account holder information, and personal identification numbers (“PIN”). Generally speaking, these standards and requirements must be met by both software and hardware components used to receive, store, transmit, or otherwise handle the sensitive information.

Compliance with PCI/EMV standards is burdensome, and makes it difficult to upgrade the dispenser so as to enhance the customer's purchasing experience. For example, if the fuel dispenser is equipped with a black and white LCD display, upgrading to a color touch screen display may often require recertification of the fuel dispenser's entire payment system. While such a requirement does generally ensure that sensitive payment information processed through the fuel dispenser remains secure, changes are costly and slow to implement. Also, regardless of information security considerations, many customers consider the time spent standing in front of the fuel dispenser's user interface to be inconvenient and, in some cases, counterintuitive.

The present invention recognizes and addresses various considerations of the prior art.

### SUMMARY OF CERTAIN ASPECTS

The present invention recognizes and addresses the foregoing considerations, and others, of prior art construction and methods. In this regard, certain exemplary and nonlimiting aspects of the present invention will now be described. These aspects are intended to provide some context for certain principles associated with the present invention, but are not intended to be defining of the full scope of the present invention.

Certain aspects of the present invention are directed to a fuel dispenser comprising fuel flow piping defining a flow path from a source of fuel toward a fueling nozzle. A plurality of fuel handling components are disposed along the fuel flow piping. Control electronics are in operative communication with the fluid handling components. The fuel dispenser includes network circuitry operative to create a wireless peer to peer network with an adjacent vehicle. After creation of such network, the control electronics receive transaction information from the vehicle in electronic form via the network circuitry, and cause at least one function of the fuel dispenser to be controlled for a transaction based on the transaction information. For example, the at least one function of the fuel dispenser may include at least one of selection of fuel grade, selection of fuel type, receipt of payment information, vehicle fuel tank quantity information, and receipt preference. In the case of vehicle fuel tank quantity information., the control electronics may be operative to vary a flow of rate fuel being dispensed based on the fuel tank quantity information.

According to some exemplary embodiments, the network circuitry communicates with in range vehicles to receive location information, and determines whether one of the vehicles is the adjacent vehicle based on the location information. According to some exemplary embodiments, the network circuitry creates a Wi-Fi direct network with the adjacent vehicle. According to some exemplary embodiments, the transaction information contains payment account indicia to effect payment for the transaction. According to some exemplary embodiments, the transaction information includes vehicle identifying indicia which are compared against a database of known customers, the database containing customer preference information used to facilitate the transaction.

Another aspect of the present invention provides a fuel dispensing environment comprising a plurality of fuel dispensers. Each of the dispensers has fuel flow piping defining a flow path from a source of fuel toward a fueling nozzle. A plurality of fuel handling components are disposed along the fuel flow piping. Control electronics are in operative communication with the fluid handling components. An infrastructure to vehicle network device in communication with each of the fuel dispensers is also provided. The device includes network circuitry operative to create a wireless peer to peer network with vehicles in the forecourt and associate each such vehicle with a respective fuel dispenser. After creation of such network, the device receives transaction information from the vehicle in electronic form via the network circuitry and causes the control electronics of the fuel dispenser to control at least one function of the fuel dispenser based on the transaction information.

A further aspect of the present invention provides a method utilized at a fuel dispenser to establish a wireless peer to peer network between the fuel dispenser and a vehicle. One step of the method involves communicating with the vehicle when within communication range of the fuel dispenser to obtain location information therefrom. According to another step, whether the vehicle is in a dispensing location adjacent to the fuel dispenser is determined based on the location information. If the vehicle is in the dispensing location, the network is established with the vehicle. Transaction information is wirelessly received from the vehicle in electronic form. At least one function of the fuel dispenser is controlled for a transaction based on the transaction information.

Different systems and methods of the present invention utilize various combinations of the disclosed elements and method steps as supported by the overall disclosure herein. Thus, combinations of elements other than those discussed above may be claimed. Moreover, the accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a perspective view of an exemplary fuel dispenser in accordance with an embodiment of the present invention.

FIG. 2 is a diagrammatic representation of internal components of the fuel dispenser of FIG. 1 according to an embodiment of the present invention.

FIG. 3 shows additional detail regarding internal components of the fuel dispenser of FIGS. 1 and 2.

FIG. 4 is a diagrammatic elevational representation of a fuel dispenser configured to create a Wi-Fi direct network with one or more vehicles adjacent thereto by which a user may interact with the dispenser for payment, information, and selection purposes.

FIG. 5 is a perspective view of the interior of the vehicle(s) of FIG. 4 showing the infotainment screen on which aspects of a fuel dispenser user interface may be shown.

FIG. 6 is a diagrammatic representation showing the formation of an ad hoc network group using the Wi-Fi direct capability of the fuel dispenser.

FIG. 7 is a flowchart showing aspects of the formation of an ad hoc network group as in FIG. 6.

FIGS. 8A-8D illustrate a series of screen displays that may be shown on the infotainment screen of FIG. 5 per the ad hoc network.

FIG. 9 is a diagrammatic representation of a fuel dispensing environment including a device separate from the fuel dispensers for creating ad hoc peer-to-peer networks with the vehicles to be refueled.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Some embodiments of the present invention may be particularly suitable for use with a fuel dispenser in a retail service station environment, and the below discussion will describe some preferred embodiments in that context. However, those of skill in the art will understand that the present invention is not so limited. In fact, it is contemplated that embodiments of the present invention may be used with any fluid dispensing environment and with other fluid dispensers. For example, embodiments of the present invention may also be used with diesel exhaust fluid (DEF) dispensers, compressed natural gas (CNG) dispensers, and liquefied petroleum gas (LPG) and liquid natural gas (LNG) applications, among others. In addition, aspects of the present invention may be applicable to other retail environments in which payment cards (or equivalent payment account indicia) are used to purchase various goods or services.

Examples of retail fueling environments, fuel dispensers, and user interfaces for fuel dispensers are provided in U.S. Pat. No. 6,435,204 (entitled “Fuel Dispensing System”), U.S. Pat. No. 5,956,259 (entitled “Intelligent Fueling”), U.S. Pat. No. 5,734,851 (entitled “Multimedia Video/Graphics in Fuel Dispensers”), U.S. Pat. No. 6,052,629 (entitled “Internet Capable Browser Dispenser Architecture”), U.S. Pat. No. 5,689,071 (entitled “Wide Range, High Accuracy Flow Meter”), U.S. Pat. No. 6,935,191 (entitled “Fuel Dispenser Fuel Flow Meter Device, System and Method”), U.S. Pat. No. 7,289,877 (entitled “Fuel Dispensing System for Cash Customers”), U.S. Pat. No. 8,438,064 (entitled “Payment Processing System for Use in a Retail Environment having Segmented Architecture”), and U.S. published patent application nos. 20090048710 (entitled “Fuel Dispenser”), 20090265638 (entitled “System and Method for Controlling Secure Content and Non-secure Content at a Fuel Dispenser or other Retail Device”), 20110185319 (entitled “Virtual PIN Pad for Fuel Payment Systems”), 20130059694 (entitled “Fuel Dispenser Application Framework”), and 20130103190 (entitled “Fuel Dispenser User Interface System Architecture”). The entire disclosure of each of the foregoing patents and applications is hereby incorporated by reference in their entirety for all purposes.

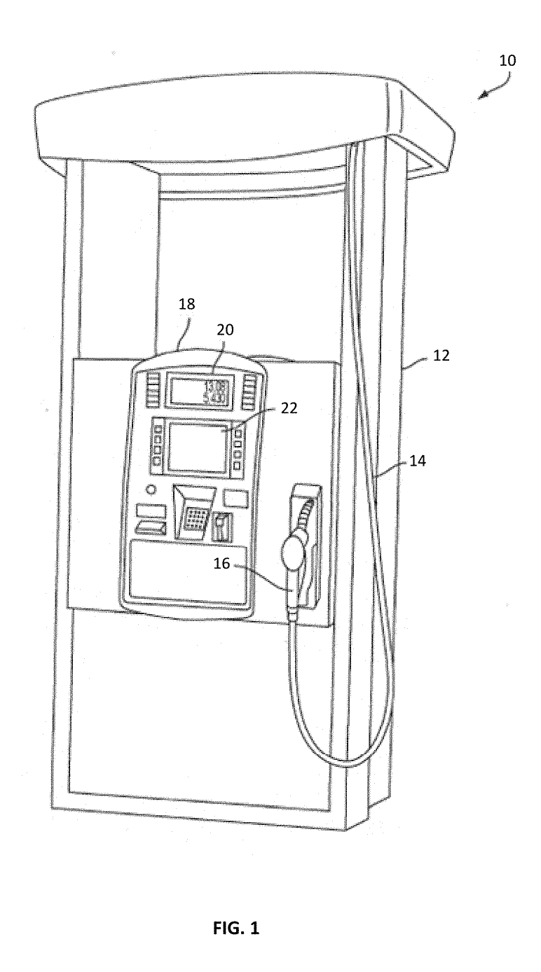

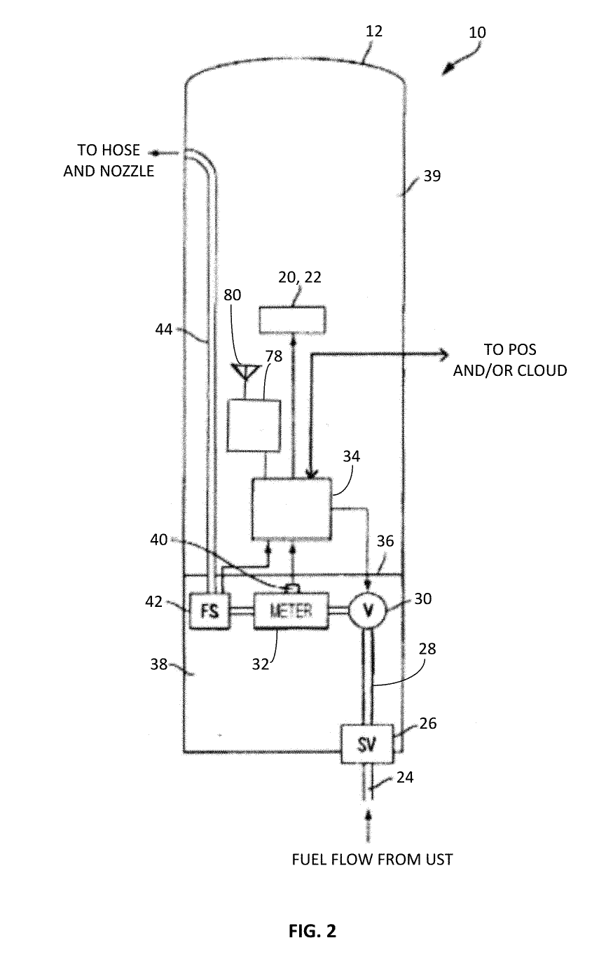

Referring now to FIGS. 1 and 2, a fuel dispenser 10 in accordance with an embodiment of the present invention will be described. One skilled in the art will recognize that many of aspects of fuel dispenser 10 are conventional, and similar to aspects described above in relation to the prior art. However, as will be explained more fully below, fuel dispenser 10 comprises electronics that produce ad hoc wireless networks with vehicles in its proximity, thus allowing user interaction with the fuel dispenser using electronics inside the vehicle or via a customer's smartphone or other portable personal device. Various advantages, some of which are explained below, can be realized as a result.

As shown in FIG. 1, fuel dispenser 10 includes a housing 12 with a flexible fuel hose 14 extending therefrom. Fuel hose 14 terminates in a manually-operated nozzle 16 adapted to be inserted into a fill neck of a vehicle's fuel tank. Nozzle 16 includes a fuel valve. As will be described more fully below with reference to FIG. 2, various fuel handling components, such as valves and meters, are also located inside of housing 12. These fuel handling components allow fuel to be received from underground piping and delivered through hose 14 and nozzle 16 to a vehicle's tank, as is well understood.

Fuel dispenser 10 has a customer interface 18. Customer interface 18 may include an information display 20 relating to an ongoing fueling transaction that includes the amount of fuel dispensed and the price of the dispensed fuel. Further, customer interface 18 may include a display 22 that provides instructions to the customer regarding the fueling transaction. Display 22 may also provide advertising, merchandising, and multimedia presentations to a customer, and may allow the customer to purchase goods and services other than fuel at the dispenser.

FIG. 2 is a schematic illustration of internal fuel flow components of fuel dispenser 10 according to an embodiment of the present invention. In general, fuel may travel from an underground storage tank (UST) via main fuel piping 24, which may be a double-walled pipe having secondary containment as is well known, to fuel dispenser 10 and nozzle 16 for delivery. More specifically, a submersible turbine pump (STP) associated with the UST is used in this embodiment to pump fuel to the fuel dispenser 10. However, some fuel dispensers may be self-contained, meaning fuel is drawn to the fuel dispenser 10 by a pump unit positioned within housing 12.

Main fuel piping 24 passes into housing 12 through a shear valve 26. As is well known, shear valve 26 is designed to close the fuel flow path in the event of an impact to fuel dispenser 10. Shear valve 26 contains an internal fuel flow path to carry fuel from main fuel piping 24 to internal fuel piping 28.

After fuel exits the outlet of shear valve 26 and enters into internal fuel piping 28, it flows toward a flow control valve 30 positioned upstream of a flow meter 32. Alternatively, valve 30 may be positioned downstream of the flow meter 32. In one embodiment, valve 30 may be a proportional solenoid controlled valve, such as described in U.S. Pat. No. 5,954,080, hereby incorporated by reference in its entirety for all purposes.

Flow control valve 30 is under control of a control system 34. Control system 34 typically controls aspects of fuel dispenser 10, such as valves, displays, and the like. For example, control system 34 instructs flow control valve 30 to open when a fueling transaction is authorized. In addition, control system 34 may be in electronic communication with a POS located at the fueling site and/or various remote servers (i.e., the “cloud”) as needed or desired. The POS communicates with control system 34 to control authorization of fueling transactions and other conventional activities.

A vapor barrier 36 separates hydraulics compartment 38 and electronics compartment 39 of fuel dispenser 10. As shown, control system 34 is located in electronics compartment 39 above vapor barrier 36. Fluid handling components, such as flow meter 32, are located in hydraulics compartment 38. In this regard, flow meter 32 may be any suitable flow meter known to those of skill in the art, including positive displacement, inferential, and Coriolis mass flow meters, among others. Meter 32 typically comprises electronics 40 that communicate information representative of the flow rate or volume to control system 34. For example, electronics 40 may include a pulser or other suitable displacement sensor as known to those skilled in the art. In this manner, control system 34 can update the total gallons (or liters) dispensed and the price of the fuel dispensed on information display 20.

As fuel leaves flow meter 32 it enters a flow switch 42, which preferably comprises a one-way check valve that prevents rearward flow through fuel dispenser 10. Flow switch 42 provides a flow switch communication signal to control system 34 when fuel is flowing through flow meter 32. The flow switch communication signal indicates to control system 34 that fuel is actually flowing in the fuel delivery path and that subsequent signals from flow meter 32 are due to actual fuel flow. Fuel from flow switch 42 exits through internal fuel piping 44 to fuel hose 14 and nozzle 16 for delivery to the customer's vehicle.

A blend manifold may also be provided downstream of flow switch 42. The blend manifold receives fuels of varying octane levels from the various USTs and ensures that fuel of the octane level selected by the customer is delivered. In addition, fuel dispenser 10 may in some embodiments comprise a vapor recovery system to recover fuel vapors through nozzle 16 and hose 14 to return to the UST. An example of a vapor recovery assist equipped fuel dispenser is disclosed in U.S. Pat. No. 5,040,577, incorporated by reference herein in its entirety for all purposes.

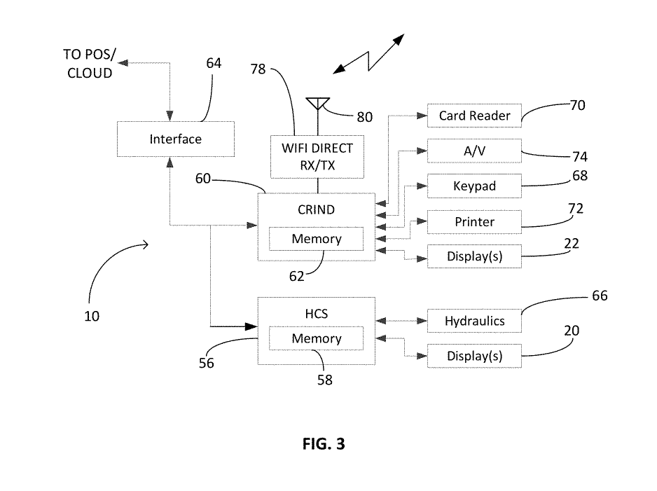

Certain additional details regarding the various components of fuel dispenser 10 will be explained with reference to FIG. 3. In this regard, control system 34 includes a hydraulic control system (“HCS”) 56 having an associated memory 58. In addition, control system 34 may also comprise a CRIND (card reader in dispenser) assembly 60 and associated memory 62. Those of ordinary skill in the art are familiar with CRIND units used in fuel dispensers, but additional background information is provided in U.S. Pat. No. 4,967,366, the entirety of which is incorporated herein by reference for all purposes. As shown, HCS 56 and CRIND assembly 60 are in operative communication with the POS of the fueling environment and/or one or more remote servers via an interface 64.

HCS 56 includes the hardware and software necessary to control the hydraulic components and functions of dispenser 10. Those of ordinary skill in the art are familiar with the operation of the hydraulics (collectively indicated at 66) of dispenser 10. In this regard, meter flow measurements from the pulser are collected by HCS 56. HCS 56 also typically performs calculations such as cost associated with a fuel dispensing transaction. HCS 56 may further be operative to control displays 20 provided on respective sides of fuel dispenser 10.

CRIND assembly 60 includes the hardware and software necessary to support payment processing and peripheral interfaces at dispenser 10. In this regard, CRIND assembly 60 may be in operative communication with several input devices. For example, a PIN pad 68 is typically used for entry of a PIN if the customer is using a debit card for payment of fuel or other goods or services. CRIND assembly 60 may also be in operative communication with a card reader 70 for accepting credit, debit, or other payment cards (e.g., magnetic stripe and/or chip cards). Additionally, card reader 70 may accept loyalty or program-specific cards as is well known. Further, CRIND assembly 60 may be in operative communication with other payment or transactional devices such as a receipt printer 72.

As noted above, display(s) 22 may be used to display information, such as transaction-related prompts and advertising, to the customer. Again, two such displays would typically be provided, one on each side of a two-sided dispenser. The customer may use soft keys to respond to information requests presented to the user via a display 22. In some embodiments, however, a touch screen may be used for a display 22.

Audio/video electronics 74 are adapted to interface with the CRIND assembly 60 and/or an auxiliary audio/video source to provide advertising, merchandising, and multimedia presentations to a customer in addition to basic transaction functions. The graphical user interface provided by the dispenser may allow customers to purchase goods and services other than fuel at the dispenser. For example, the customer may purchase a car wash and/or order food from the store while fueling a vehicle.

Conventionally, a user positions a vehicle adjacent to one of dispensers 10 and uses the dispenser to refuel the vehicle. For payment, the user inserts and removes a payment card from card reader 70. Card reader 70 reads the information on the payment card which is then transmitted, such as via a POS system, to a financial institution's host server for approval. The financial institution either validates or denies the transaction and transmits such a response. If the transaction is approved, dispensing of fuel is allowed.

The conventional process is improved according to aspects of the present invention. In this regard, vehicles that may need to be refueled using fuel dispenser 10 are often equipped with anti-collision systems to lessen the occurrence of collisions between the vehicle and other objects, such as other vehicles, cyclists, pedestrians, etc. These systems rely on connectivity for supplying and receiving relevant parameters such as GPS coordinates, velocity, and trajectory. A new method that is gaining acceptance for this purpose is referred to in industry parlance as “Wi-Fi Direct,” which as applied in the vehicle context is often referred to as V2V (“vehicle-to-vehicle”). Connect time is typically around one second or less, and security is maintained by limitation and specificity of services upon connection being granted. Notably, instead of a typical Wi-Fi Access Point (AP) with router forming a star-type connection, with all devices attached to the router being in full communication and therefore in exposure to other devices, Wi-Fi Direct is instead ad hoc, one to one, and may limit connections to specific services. Consequently, vehicles may now rapidly connect ad hoc with other in range vehicles to communicate speed, direction and/or GPS position for purposes of collision avoidance, typically within a 200-yard radius. However, this capability allows for the possibility of other uses as described herein.

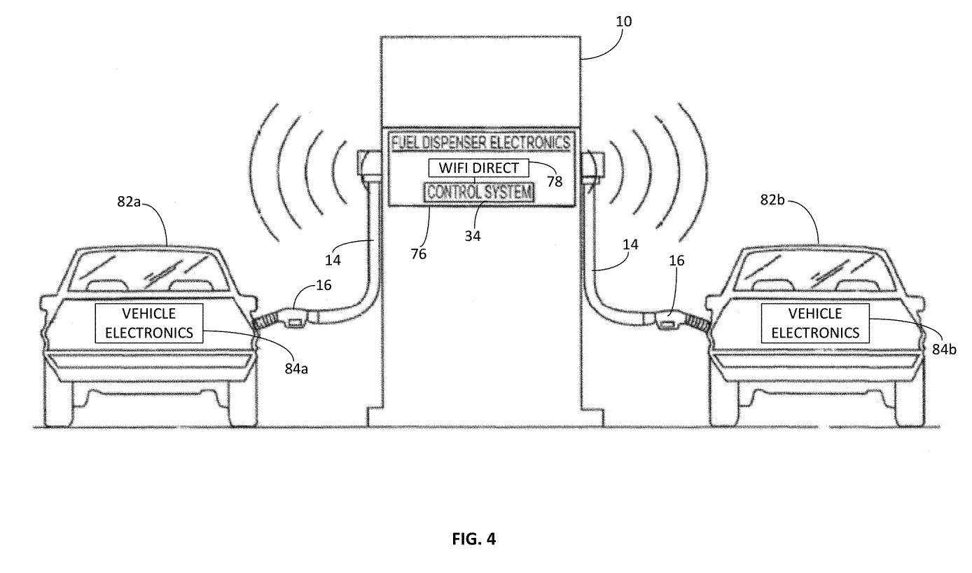

Referring now also to FIG. 4, the electronics 76 of fuel dispenser 10 are equipped with circuitry, denoted Wi-Fi Direct circuitry 78 (which include one or more suitable antenna(e) 80 as shown in FIG. 2) that allows for the creation of ad hoc wireless networks on a one-to-one basis with suitably-equipped vehicles in the area (e.g., within a 200-yard radius). In this regard, a pair of vehicles 82a-b are shown adjacent to fuel dispenser 10 in the refueling position. Nozzles 14 are each inserted into the fill neck of the respective vehicle's fuel tank to receive fuel when authorized dispensing has begun.

In this case, both of vehicles 82a-b are equipped with vehicle electronics 84a-b allowing the creation of an ad hoc peer to peer network with a suitably equipped fuel dispenser. Wi-Fi Direct circuitry 78 functions to detect the presence of vehicles 82 to form the one to one networks on an as-needed basis. Preferably, but not critically, the connectivity may be prearranged by the parties, such that agreed-upon services may be established. These services may be revised or expanded over time as capabilities of the dispenser and/or needs of the customer change. For example, in a preferred embodiment, circuitry 78 may provide wireless connectivity with the vehicle in accordance with standard 802.11p.

By way of further explanation, because fuel dispenser 10 “knows” the vehicle's proximity and location (e.g., as provided to it by the vehicle itself) when in range, it will also know when the vehicle is in the refueling position. For the dispenser and the associated payment subsystem, timely recognition and association of the vehicle is possible (via the vehicle's SSID or other identifying indicia) from a previous transaction at that dispenser or through information to which the fuel dispenser has access such as via cloud connectivity. If the vehicle is not associated with a previous transaction, it will be after completion of the current transaction (through local or cloud storage of the vehicle identifying information).

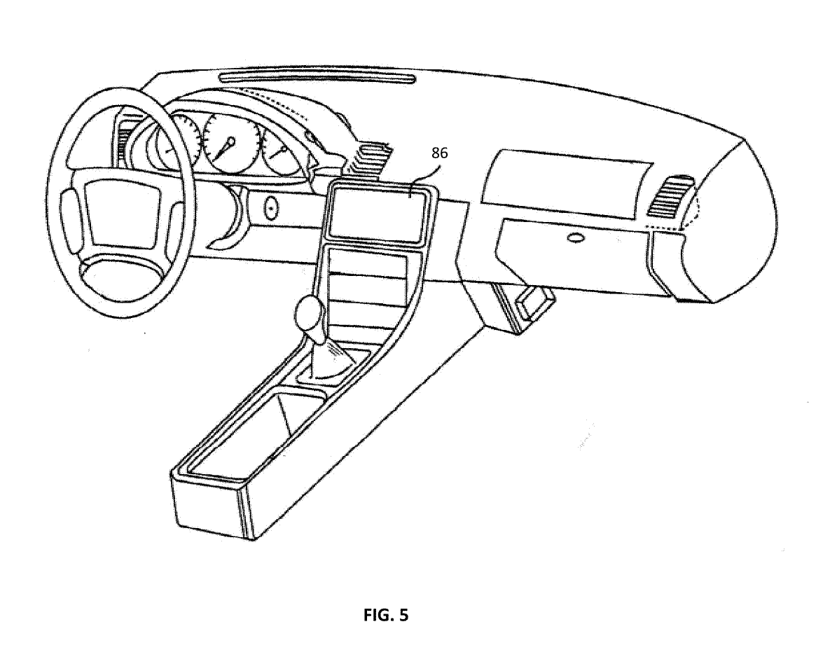

Because Wi-Fi Direct can be used to couple a motorist's smartphone (or other such portable device) with the vehicle, the smartphone now becomes part of the fuel dispenser connectivity. In this regard, because personal devices such as smartphones and vehicles are not classified as public terminals, they are exempt from PCI requirements. Consequently, financial transactions for dispensers may occur via vehicle-to-dispenser, smartphone-to-dispenser, or by combinations of those devices, either computationally, by network establishment, by user interface, and/or by connectivity paths among and between those devices. For example, all dispenser interaction except nozzle insertion and removal could take place within the vehicle such as using the vehicle's infotainment touchscreen 86 (FIG. 5).

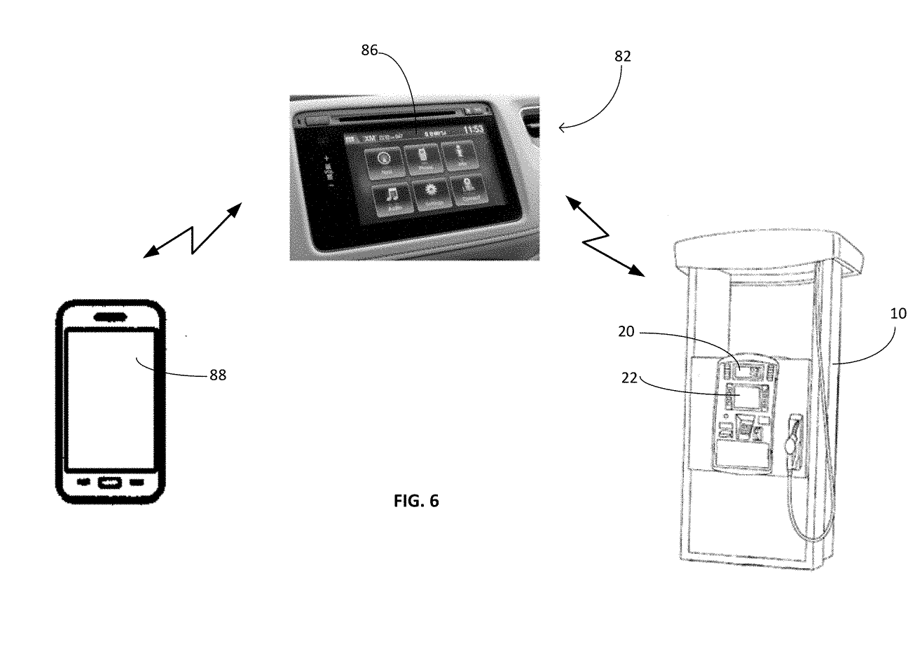

In this regard, FIG. 6 illustrates an ad hoc network between fuel dispenser 10, vehicle 82, and a customer's smartphone 88. Once the network is established, any information shown on displays 20 and 22 may be also shown on infotainment screen 86, as well as the screen of smartphone 88. As noted above, the customer may thus use the infotainment screen 86 or the screen of the smartphone 88 to receive information about and make selections for the fueling transaction. These functions are predefined as the services allowed by the network connectivity. By way of example, such services may include:
Payment Facilitation (retail automation).
Fuel grade selection at the time of fueling, or preference preselection (e.g., via an enrollment process or knowledge of previous fuel selection), which can preferably be overridden for container filling.
Prohibition of certain fuel type (no gasoline into a diesel engine, or vice versa), which can preferably be overridden for container filling.
Facilitation of refueling with knowledge of measured fuel level and/or ullage within the vehicle tank. In this regard, the Environmental Protection Agency (EPA) limits flow rate of dispensers in the United States to ten gallons per minute to minimize risk of splash back at the fill neck (and resulting environmental contamination). According to the present invention, the vehicle can provide information regarding the fuel level in the vehicle tank to the dispenser as the tank is being filled. As a result, flow rates could exceed 10 gallons per minute when the fuel level is low, and be curtailed to 10 gallons/minute or less when the fuel level is nearer to full.
Drive Off system—Once the vehicle is able to communicate with the dispenser, the dispenser tells the car that the nozzle is not hung up, therefore it is still in the fill pipe of the vehicle. If a driver attempts to start the car to leave the store, they get an in vehicle warning that the dispenser nozzle is still attached requiring a manual override before they can start the car. This not only would eliminate drive offs with connected cars, it would also enforce local/national laws that the vehicle must be turned off during fueling.
Camera in the Pump—The dispenser and the store video security system may be connected whereas at the beginning of the transaction while the consumer is in front of the dispenser, display the dispenser camera feed (video of the person's face in front of the pump) on the dispenser's display plus optionally other windows feeding shots of the car in the pump lane (e.g., from multiple angles). A message could also be displayed informing the customer that the transaction is being recorded on video. There are a few benefits: People using fraudulent cards would not do so at a dispenser equipped this way, people intending to drive off would not, and people who scratch or paint graffiti on the dispenser would not do so. (In addition, the dispenser could be configured when idle to show multiple windows of the security cameras thereby scaring off a non-motorist that is intending to vandalize the pump.)
Add Datapass Plus modules to the OBD port that transmit engine data and odometer readings to the fleet system. Dispenser vehicle communication can determine that fuel is actually flowing into the vehicle versus a gas can and that the vehicle is actually in front of the specific pump, not on the other side. A low cost tech adder to existing vehicles and transport trucks could eliminate the need for the nozzle/ring systems.

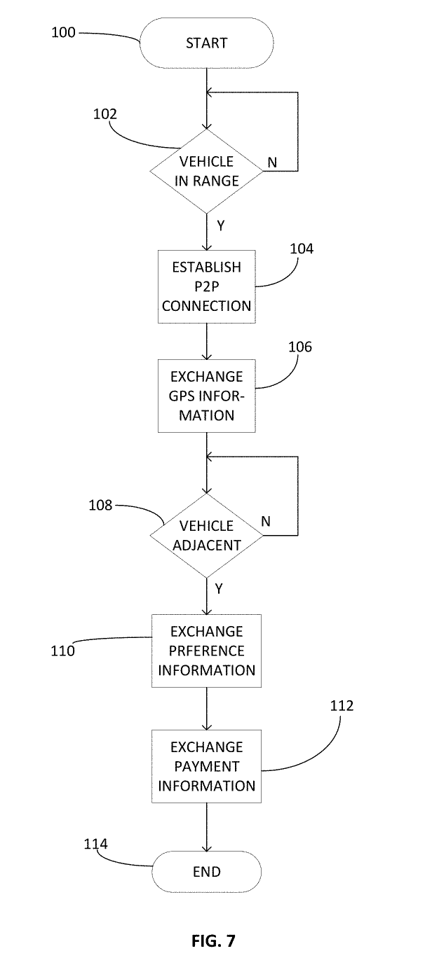

FIG. 7 illustrates a process for establishing an ad hoc network in accordance with an aspect of the present invention. After the process begins (as indicated at 100), a determination of whether a vehicle is in range (e.g., within 200 yards) is made (as indicated at 102). If no vehicle is in range, the search continues. If a vehicle is in range, a peer-to-peer (“P2P”) connection is established between the fuel dispenser and the vehicle (as indicated at 104). The vehicle, knowing its exact location, supplies location information to the fuel dispenser (as indicated at 106).

The fuel dispenser determines whether the vehicle is in a dispensing lane (as indicated at 108). If so, the vehicle may provide information relevant to the transaction, such as selected type or grade of fuel (as indicated at 110). Information regarding a preferred method of payment can also be provided to the fuel dispenser so that the dispensing transaction can be pre-authorized (as indicated at 112). (Or, the information at steps 110 and 112 may be retrieved from a database by the dispenser based on the vehicle's identity.) During fueling, information regarding the cost and volume of fuel dispensed can be provided from the fuel dispenser to the vehicle. At the conclusion of the transaction, payment is finalized and confirmation thereof is provided to the vehicle (as indicated at 112). The process ends at 114.

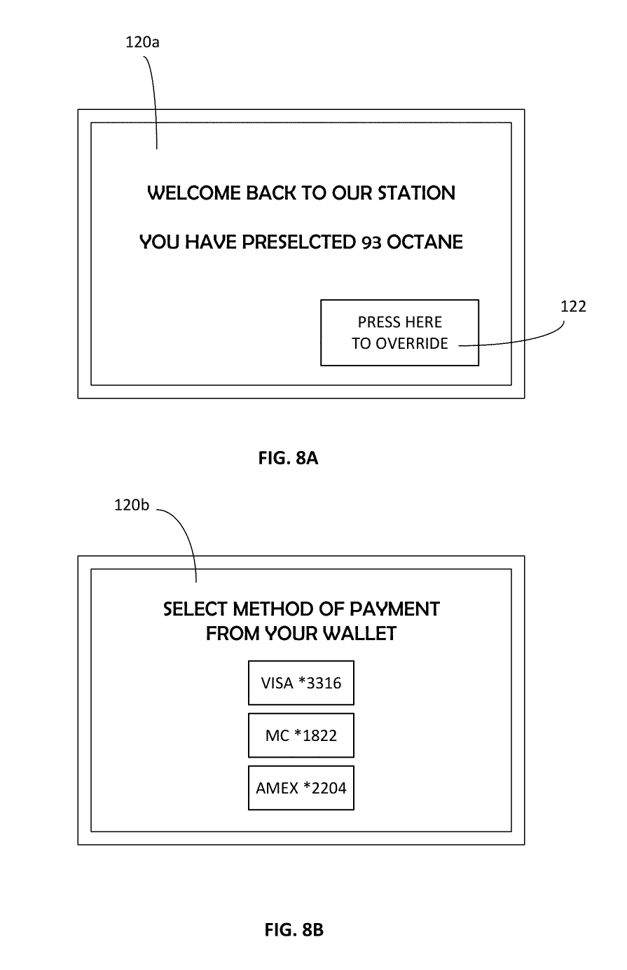

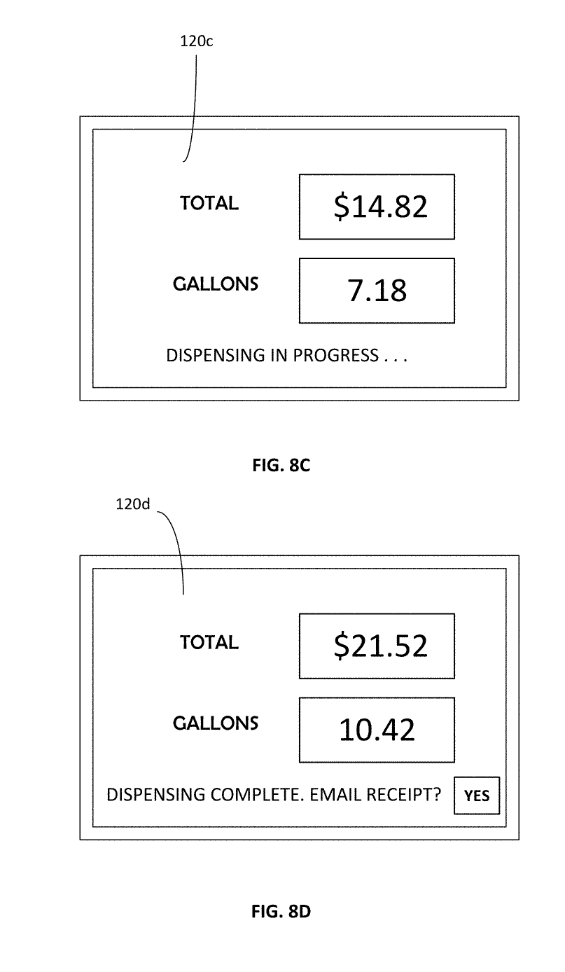

FIGS. 8A through 8D show a series of exemplary screen images 120a-d that that may be shown on infotainment screen 86 or the display of smartphone 88 via the ad hoc network when it is determined that the vehicle is in the fueling position. In FIG. 8A, image 120a indicates that the customer has preselected to receive 93 octane gasoline. An option is provided, as shown at 122, should the customer decide or need to override the preselected preference.

In FIG. 8B, the customer is given the option at screen image 120b to select a particular payment method from among several designated methods of payment (such as those stored on the customer's smartphone in its electronic “wallet”).

In FIG. 8C, screen 120c shows the volume and cost of fuel dispensed in real time during the fueling transaction. In FIG. 8D, screen 120d shows the final volume and cost of fuel dispensed when fueling is complete. The customer may be asked whether a receipt by email is desired, such as using a preselected email address or an email address that is provided after preference for an email receipt is indicated.

While embodiments described above utilize individual fuel dispensers communicating with a vehicle, in an additional embodiment, communications with a vehicle may also be facilitated by Wi-Fi direct (also known as 802.11p) as based upon a centralized 802.11p radio; for example, located at kiosk or other structure that is in direct or indirect communications with the fuel dispenser(s). Moreover, and preferably, this shared or common 802.11p radio is preferably associated with the refueling site's Point of Sale (POS) controller, it already having and established connections with fuel dispenser(s), whether wired or wireless.

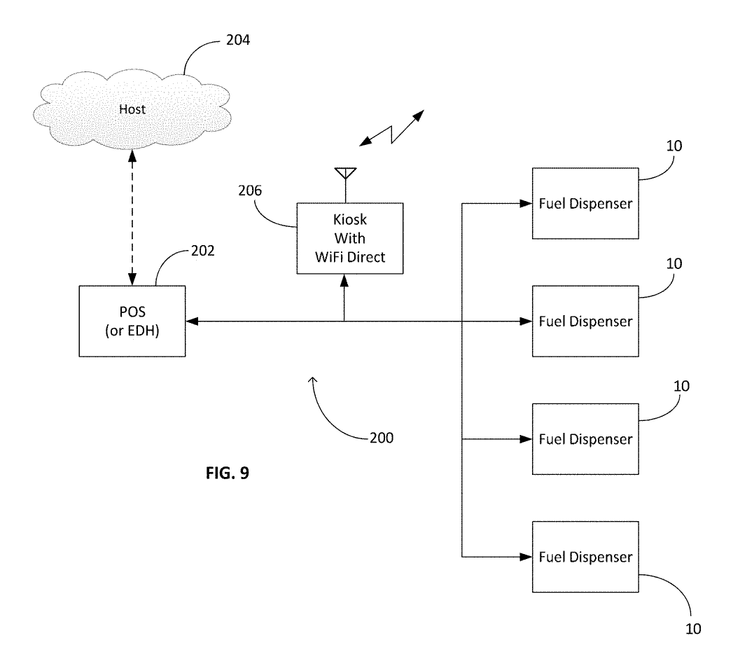

In this regard, FIG. 9 illustrates a retail fuel dispensing environment 200 having a plurality of fuel dispensers 10 located in its forecourt region. As shown, fuel dispensers 10 are in communication with a point of sale system (POS) 202, which is itself in communication with a remote host 204. (Alternatively, an enhanced dispenser hub, or “EDH,” as disclosed in U.S. Pat. No. 8,438,064, may communicate with the dispensers 10 and host 204, in which case the POS would be a separate device in communication with the EDH.) As shown, a separate infrastructure-to-vehicle network device, here in the form of kiosk 206, is provided to establish ad hoc peer-to-peer networks with vehicles in the forecourt. Kiosk 206 communicates with the respective one of fuel dispensers 10 with which each of the vehicles is respectively associated and, along with the various fuel dispensers 10, effects functionality as otherwise described above.

While one or more preferred embodiments of the invention have been described above, it should be understood that any and all equivalent realizations of the present invention are included within the scope and spirit thereof. Thus, the embodiments depicted are presented by way of example only and are not intended as limitations upon the present invention as modifications can be made. Therefore, it is contemplated that any and all such embodiments are included in the present invention as may fall within the scope and spirit thereof.

What is claimed is:

1. A fuel dispenser comprising:
fuel flow piping defining a flow path from a source of fuel toward a fueling nozzle;
a plurality of fuel handling components disposed along said fuel flow piping;
control electronics in operative communication with said fluid handling components; and
said fuel dispenser including network circuitry operative to create a wireless peer to peer network with an adjacent vehicle and, after creation of such network, receive transaction information from the vehicle in electronic form via the network circuitry, said control electronics causing at least one function of the fuel dispenser to be controlled for a transaction based on said transaction information.

2. A fuel dispenser as set forth in claim 1, wherein said at least one function of the fuel dispenser includes at least one of selection of fuel grade, selection of fuel type, receipt of payment information, vehicle fuel tank quantity information, and receipt preference.

3. A fuel dispenser as set forth in claim 2, wherein said network circuitry communicates with in range vehicles to receive location information, and determines whether one of said vehicles is said adjacent vehicle based on said location information.

4. A fuel dispenser as set forth in claim 1, wherein said network circuitry creates a Wi-Fi direct network with said adjacent vehicle.

5. A fuel dispenser as set forth in claim 4, wherein said transaction information contains payment account indicia to effect payment for the transaction.

6. A fuel dispenser as set forth in claim 4, wherein said transaction information includes vehicle identifying indicia which are compared against a database of known customers, said database containing customer preference information used to facilitate the transaction.

7. A fuel dispenser as set forth in claim 1, wherein said at least one function of the fuel dispenser includes vehicle fuel tank quantity information.

8. A fuel dispenser as set forth in claim 7, wherein said control electronics are operative to vary a flow of rate fuel being dispensed based on the fuel tank quantity information.

9. A fuel dispensing environment comprising:
a plurality of fuel dispensers, each of the dispensers having:
fuel flow piping defining a flow path from a source of fuel toward a fueling nozzle;
a plurality of fuel handling components disposed along said fuel flow piping;
control electronics in operative communication with said fluid handling components; and
an infrastructure to vehicle network device in communication with each of said fuel dispensers, said device including network circuitry operative:
to create a wireless peer to peer network with vehicles in the forecourt and associate each such vehicle with one of said fuel dispensers, and
after creation of such network to receive transaction information from the vehicle in electronic form via the network circuitry and to cause the control electronics of the fuel dispenser to control at least one function of the fuel dispenser based on said transaction information.

10. A fuel dispensing environment as set forth in claim 9, wherein said at least one function of the fuel dispenser includes at least one of selection of fuel grade, selection of fuel type, receipt of payment information, vehicle fuel tank quantity information, and receipt preference.

11. A fuel dispensing environment as set forth in claim 10, wherein said network circuitry communicates with in range vehicles to receive location information, and determines whether one of said vehicles is adjacent to one of said fuel dispensers based on said location information.

12. A fuel dispensing environment as set forth in claim 9, wherein said network circuitry creates a Wi-Fi direct network with said vehicles.

13. A fuel dispensing environment as set forth in claim 9, wherein said transaction information contains payment account indicia to effect payment for the transaction.

14. A fuel dispensing environment as set forth in claim 13, wherein said transaction information includes vehicle identifying indicia which are compared against a database of known customers, said database containing customer preference information used to facilitate the transaction.

15. A fuel dispensing environment as set forth in claim 9, wherein said at least one function of the fuel dispenser includes vehicle fuel tank quantity information.

16. A fuel dispensing environment as set forth in claim 15, wherein said control electronics are operative to vary a flow of rate fuel being dispensed based on the fuel tank quantity information.

17. A method utilized at a fuel dispenser to establish a wireless peer to peer network between the fuel dispenser and a vehicle, said method comprising steps of:
(a) communicating with said vehicle when within communication range of said fuel dispenser to obtain location information therefrom;
(b) determining based on said location information whether said vehicle is in a dispensing location adjacent to said fuel dispenser;
(c) if said vehicle is in said dispensing location, establishing said network with said vehicle;
(d) wirelessly receiving transaction information from the vehicle in electronic form; and
(e) causing at least one function of the fuel dispenser to be controlled for a transaction based on said transaction information.

18. The method as set forth in claim 17, wherein said range is less than approximately 200 yards.
